(19) United States
(12) Patent Application Publication
(10) Pub. No.: US 2009/0089004 A1
(43) Pub. Date: Apr. 2, 2009

(54) Time Learning Test System

(76) Inventors: Dietrich Werner Vook, Los Altos, CA (US); Douglas M. Baney, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/862,827

(22) Filed: Sep. 27, 2007

(51) Int. Cl. G06F 19/00

(52) U.S. Cl. 702/123

(57) ABSTRACT

A time-learning test system for running a test program on a device under test (DUT) is disclosed. A command is sent from a controller to an instrument. A preset wait period is observed in the test program. A response time of the instrument to the command is determined. The preset wait period is adjusted based on the response time.

### BACKGROUND

Test systems typically include multiple instruments and a controller that controls the multiple instruments. These test systems are used in manufacturing environments to test factory output, and are also used in other environments such as research facilities, laboratories, and anywhere else where a test system governed by a controlling test program may be used. The controller runs test program software that instructs the instruments to make measurements on a device under test, change device settings, etc. Exemplary instruments include multimeters, power supplies, oscilloscopes, signal analyzers, network analyzers, logic analyzers, spectrum analyzers, data analyzers, protocol analyzers, frequency counters, bit error rate testers, signal generators, function generators, trigger generation devices, lasers, power meters, polarimeters, wavemeters, time domain reflectometers, optoelectronic component analyzers, etc.

In many test systems, the time it takes for the instruments to be ready to make measurements can vary. For example, the instruments may need to warm up (e.g. to settle a temperature sensitive measurement) or let the electrical environment quiet down. In some cases, the device under test needs time to settle after a change in an input stimulus. Or, an instrument may need to wait for a connecting switch (e.g. a reed relay) to close completely prior to making a measurement. In all of these situations, a given measurement is more likely to be incorrect if the instrument does not wait long enough before making the measurement.

These problems can be handled by inserting WAIT periods or specified delays into the test programs. These WAIT periods can be inserted into the test software, or into operator procedures. Sometimes a delay is inserted without fully understanding why it is used: the test program completes successfully with the delay, and fails without it, but no one knows why.

However, as the test program is ported from one test system to another, or from a design environment to a production environment, these WAIT periods may need adjustment. For example, different test systems may have differences in the speed of their processors, cable lengths, warm-up transient times, etc.

The speed of a test program is an important factor, especially in manufacturing environments. For production tests, the faster the test, the fewer test systems are needed to test the factory output. If there are excessive WAIT periods in the test program, this results in wasted time and money. Adjusting the WAIT periods by hand is a time consuming process, and is typically not done. What is needed is a test system that can dynamically adjust WAIT periods to optimize the speed of a test program.

### BRIEF DESCRIPTION OF THE DRAWINGS

FIG. 1 shows a block diagram of an exemplary test system in which a test program having dynamically adjusted WAIT periods can be used.

FIG. 2 shows a flow chart for a test program having dynamically adjusted wait periods.

FIG. 3 shows a block level diagram of an instrument suitable for use in the test system of FIG. 1.

FIG. 4 illustrates a method that can be run by the instrument to report a time Tᵣₑₛₚₒₙₛₑ back to the controller.

### DETAILED DESCRIPTION

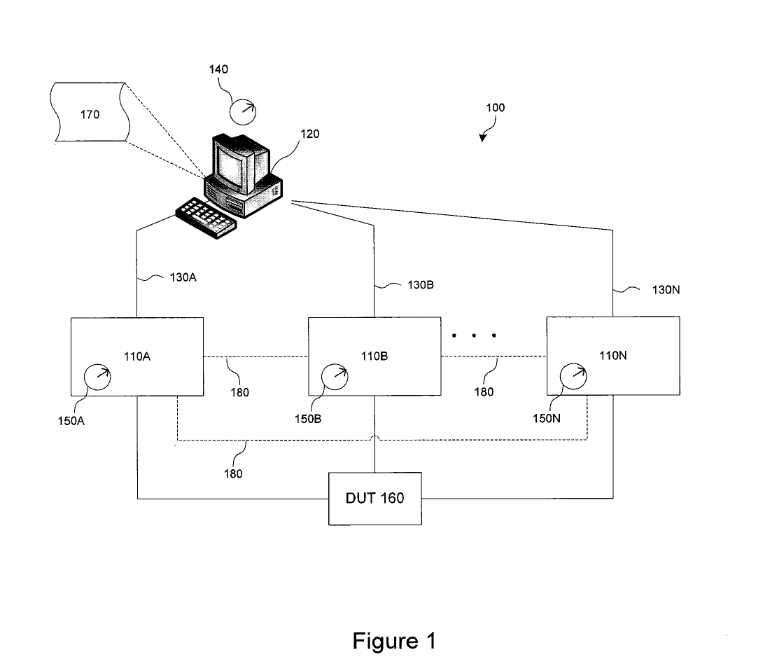

FIG. 1 shows a block diagram of an exemplary test system 100 in which a test program having dynamically adjusted WAIT periods can be used. N instruments 110A-110N are in communication with a controller 120 and a device under test (DUT) 160. The number N of instruments 110 in the test system 100 can be any integer greater than or equal to one. In the figure, the controller 120 is shown as a separate external unit such as a computer, workstation, or other processor unit. However, the controller 120 can be embedded into or co-located with one or more of the instruments 110A-110N.

The controller 120 runs a test program 170 that controls the instruments 110A-N. The controller 120 uses communication links 130A-N to communicate with each of the instruments 110A-N. Communication links 130A-N can be implemented using physical connections (including electrical and optical cable) or wireless connections (including infrared and RF). Some examples of suitable communication links include Hewlett Packard Interface Bus (HPIB), General Purpose Interface Bus (GPIB), LAN Extensions for Instrumentation (LXI), Ethernet links, etc. The controller 120 has a local clock 140, and each instrument has a local clock 150A-N. In some embodiments, the instruments 110A-N are also able to communicate with one another via communication links 180 between the various devices

Suppose for example that instrument 110A is a function generator providing a test input stimulus to the DUT 160, device 110B is a digital multimeter that measures an output of the DUT 160, and device 110N is a power supply that supplies the power for the DUT 160. DUT 160 could be a cell phone, a laptop computer, a personal digital assistant (PDA), an automotive electronic module such as an engine control unit (ECU), etc. The DUT 160 may also be a proxy of a DUT which may be used during development of the test system 100 when an actual DUT may not available. (For example, the proxy could be a simple open or closed connection, a reflection of a signal sent to the proxy, a simulation of an actual DUT, etc.) An excerpt of code from an exemplary test program 170 that might run on controller 120 is shown below in Table 1:

TABLE 1

| Line | Code |
|---|---|
| 0 | Close (@1) “close a switch” |
| 1 | Send(110A, “Frequency:Sine:16kHz”) |
| 2 | Wait T1 seconds |
| 3 | Send(110B, “Measure:Voltage”) |
| 4 | Wait T2 seconds |
| 5 | Send(110N, “Set Voltage:4.5”) |
| 6 | Open (@1) “open a switch” |

Note that this excerpt is not syntactically or semantically correct—it is just high-level pseudo-code that represents a language that might actually be used to write a test program. A complete test program will include many more lines of code than what is shown here in Table 1. The test program 170 can be written in a programming language such as C, but more often is developed within or as part of a test development environment such as LAB-view (made by National Instruments Co.), VEE (made by Agilent Technologies, Inc.), MATLAB, or any other software package that can be installed on a controller and used to control a test system.

Lines 0 and 6 are used to open or close a switch (not shown in FIG. 1) between the instruments 110 and the DUT 160.

Lines 1, 3, and 5 of code represent different commands sent by the controller 120 to an instrument. These three lines of code following the template of: Command (Instrument, Instruction). The command in all three lines is “Send”, asking the controller 120 to send the “Instruction” to the applicable “Instrument”.

Lines 2 and 4 are WAIT commands. In line 2, the controller 120 pauses and waits for a period of T1 seconds after sending the instruction to generate a 16 kilohertz (kHz) sine wave to the function generator 110A. In line 4, the controller 120 pauses and waits for a period of T2 seconds after sending the instruction to “Measure Voltage” to the digital multimeter 110B, before continuing on to the next command at line 5.

As explained earlier, there are various reasons why a WAIT command may be needed within the test program 170. In the example of Table 1, the WAIT command in line 2 could be used to allow enough time for the output of the function generator 110A to settle before proceeding with the next command. The WAIT command in line 4 could be used to allow the output of the DUT 160 to settle in response to the new stimulus from the function generator 110A, prior to measuring the output voltage with the digital multimeter 110B. And, in some circumstances, the reason for the WAIT command may be unknown, but it allows the test program 170 to complete successfully.

This WAIT command is only an example of how the controller may be paused before continuing to the next command. The WAIT command can be coded as a pause, delay, or any programming construct used to pause the program while waiting for an instrument to complete a command or instruction. There can be hundreds of WAIT commands interspersed throughout a test program.

Previously, the time periods used in the WAIT commands were hardcoded intervals. For example, instead of T1 in line 2 of the code, a user might have inserted the number “3”; instead of T2 in line 4 of the code, the number “0.5” might have been used. As mentioned earlier, however, the lengths of such hardcoded time intervals may have been set at a time when the test program was still being tested, debugged, or developed. The time intervals may not need to be as long once the test program is finished.

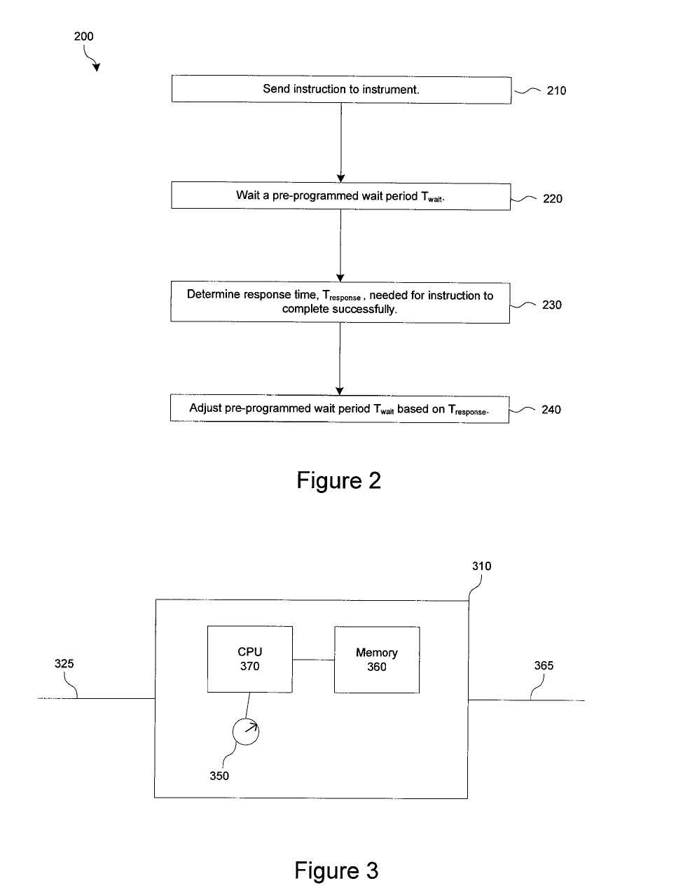

FIG. 2 shows a flow chart 200 of an exemplary method for a test program having dynamically adjusted WAIT periods for controlling a test system such as test system 100.

In step 210, the controller 120 sends a command to an instrument 110.

Next in step 220, the controller 120 waits for a pre-programmed waiting period T_{wait} (such as T1 or T2) before continuing on to the next command. The value for T_{wait} can be set during test or development of the test program, or given a set default value that is extremely long so as to allow enough time for the previous command(s) to complete successfully.

Then in step 230, the controller 120 determines a response time, Tᵣₑₛₚₒₙₛₑ, needed for the previously sent instruction to complete successfully. The definition of a successful completion will depend on the particular instruction, the instrument to which the instruction was sent, the DUT 160 being tested, and the circumstances and environment in which the instruction is to be carried out. Generally, Tᵣₑₛₚₒₙₛₑ is the length of time required to complete an instruction from the controller 120 within the required specifications or parameters.

For example, in line 1 of Table 1, the function generator 110A is instructed to generate a sine wave at a frequency of 16 kiloHertz as input to the DUT 160. However, it may take some time for the output of the function generator 110 to settle into the proper waveform and the proper frequency. Therefore, to ensure that the output of the function generator is steady before continuing, the test program has a pre-set WAIT period of T1 seconds (line 2, Table 1) to allow the output of the function generator 110 to settle before proceeding to the next instruction. In this situation, the response time Tᵣₑₛₚₒₙₛₑ would be the length of time required for the function generator 110 output to settle to a steady-state waveform of the desired shape and frequency.

In another example, in line 3 of Table 1, the digital multimeter 110B is instructed to measure the output voltage of the DUT 160. The digital multimeter 110B may be capable of executing this instruction relatively quickly. However, the output of the DUT 160 may still be transitioning in response to the change in the input stimulus to a sine wave of 16 kHz. If the test program needs to measure a steady DUT output, but the output is still transitioning, a measurement made immediately after the input stimulus to the DUT 160 is changed would return an inaccurate result. Therefore, to ensure that the output of the DUT 160 is steady before continuing, the test program has a pre-set WAIT period of T2 seconds (line 4, Table 1) to allow the output of the DUT 160 to settle before proceeding to the next instruction. In this situation, the response time Tᵣₑₛₚₒₙₛₑ would be the length of time required for the DUT 160 to settle to a steady output.

Finally in step 240, the controller 120 adjusts the pre-programmed wait period T_{wait} (e.g. T1 or T2) based on the response time Tᵣₑₛₚₒₙₛₑ determined in step 230.

There are many ways in which the response time Tᵣₑₛₚₒₙₛₑ in step 230 can be determined. For example, many instruments can be configured to report back with a “command complete” response when the command is completed. For example, after receiving the command to output a 16 kHz sine wave in line 2 of Table 1, the function generator 110A can respond to the controller with a “command complete” once its output settles to the proper form. In one embodiment, the clock 140 in the controller 120 is used to measure a start time at the start of sending a command to an instrument, and an end time when a response of “command complete” is received from the instrument. The controller calculates Tᵣₑₛₚₒₙₛₑ, which is the difference between the start time and end time. T_{wait} is then adjusted based on the measured Tᵣₑₛₚₒₙₛₑ as described in step 240. A sample high-level pseudo-code excerpt of a test program implementing this embodiment is shown below in Table 2:

TABLE 2

| Line | Code |
|---|---|
| 1 | Tₛₜₐᵣₜ=Time(clock 140) |
| 2 | Send(110A, “Frequency: Sine: 16kHz”) |
| 3 | Wait T_{wait} seconds |
| 4 | If (Command Complete(110A) = True), Tₛₜₒₚ=Time(clock 140) |
| 5 | Tᵣₑₛₚₒₙₛₑ = Tₛₜₒₚ − Tₛₜₐᵣₜ |
| 6 | Adjust(T_{wait}, Tᵣₑₛₚₒₙₛₑ) |

In Line 1, the start time Tₛₜₐᵣₜ is recorded as the time of the clock 140 in the controller 120 just before a command is sent (in Line 2) to the instrument 110A. In Line 3, a WAIT period of T_{wait} seconds is observed by the controller 120. Then in Line 4, when the instrument 110A returns a “command complete” response, the end time Tₛₜₒₚ is recorded as the time of the clock 140.

In Line 5, the response time Tᵣₑₛₚₒₙₛₑ is calculated as the difference between Tₛₜₐᵣₜ and Tₛₜₒₚ. In Line 6, the wait period T_{wait} is adjusted based on the measured response time Tᵣₑₛₚₒₙₛₑ. How the wait period is adjusted in response to the response time Tᵣₑₛₚₒₙₛₑ will depend on the particular application. In some programs, T_{wait} can just be set to equal the measured Tᵣₑₛₚₒₙₛₑ. More details on how the wait period T_{wait} can be adjusted will be discussed below.

In another embodiment, the instrument itself reports the time Tᵣₑₛₚₒₙₛₑ back to the controller 160 when the command completes. FIG. 3 shows a block level diagram of an instrument 310 that is suitable for use in test system 100. The instrument 310 has a local clock 350, a memory 360, a processor (CPU) 370, a controller port 325 for communicating with a controller, and a DUT port 365 for communicating with a DUT.

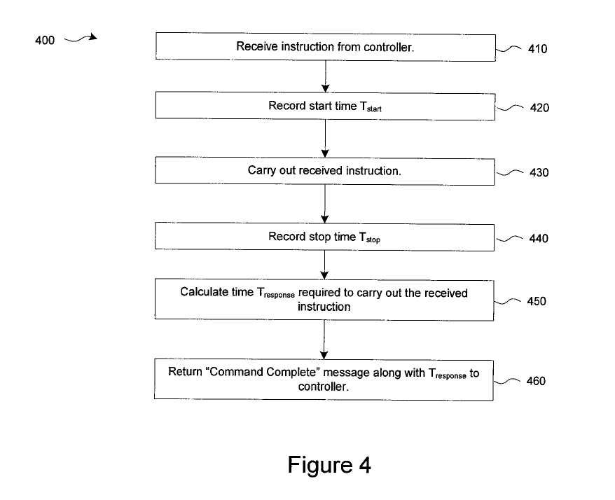

FIG. 4 illustrates a method 400 that could be run by the instrument 310 to report the time Tᵣₑₛₚₒₙₛₑ back to the controller. In step 410, the instrument 310 receives an instruction from the controller. In step 420, the CPU 370 records the time Tₛₜₐᵣₜ Of local clock 350 at the start of performing the instruction. Tₛₜₐᵣₜ can be stored in the memory 360 of the instrument 310. Next in step 430, the instrument 310 carries out the instruction received. Then in step 440, the CPU 370 records the time Tₛₜₒₚ of the local clock 350 once the instruction is completed. Then in step 450, the CPU 370 calculates the time Tᵣₑₛₚₒₙₛₑ required to carry out the instruction (e.g. Tᵣₑₛₚₒₙₛₑ=Tₛₜₒₚ−Tₛₜₐᵣₜ). Finally in step 460, the CPU 370 returns a “Command Complete” message to the controller, along with the time Tᵣₑₛₚₒₙₛₑ it took to complete the instruction received in step 410.

In some circumstances, the response time Tᵣₑₛₚₒₙₛₑ can not be determined directly by relying on a “command complete” response from the instrument. For example, in the instruction above from Table 1, line 3, the output of the DUT 160 needs to settle before its output voltage can be measured by the digital multimeter 110B. The settling time of the DUT 160 is not accounted for by the “command complete” response from the digital multimeter 110B. Instead, in one embodiment the controller analyzes the measurement made by the digital multimeter 110B and determines whether it falls within specified parameters for an acceptable response. If the measurement result does not fall within acceptable limits set by the test program, the WAIT period should be increased until a reasonable measurement result is obtained.

In one embodiment, an optimum WAIT period can determined by simply reducing the WAIT period systematically until the test program fails to complete successfully. Instead of calculating the WAIT period based on “Command Complete” feedback messages from the instruments, the WAIT period can be made progressively smaller and smaller at each iteration of the test program, until the test program fails to complete. Then the WAIT period is set to a value before the failure occurred.

In one embodiment, the instruments 110A-N communicate directly with each other along communication links 180, peer-to-peer, in order to advance the test program 170. The controller 120 sets up the instruments beforehand to communicate status messages to one another. To implement the test program of Table 1 in peer-to-peer mode, for example, the controller 120 would require the function generator 110A to send out a “Command Complete” message to all of the instruments on communication links 180 once it has generated a steady 16 kHz sine wave. The controller 120 also sets up the digital multimeter 110B to look for a “Command Complete” message from the function generator 110A—when that message is received, the digital multimeter should measure the output voltage of the DUT 160. The digital multimeter 110B should also be pre-programmed by the controller to wait a preset WAIT period to allow the DUT output to settle before performing the measurement. When the digital multimeter 110B is finished with its measurement, it should also send out a “Command Complete” message on communication links 180. By continuing in this manner and communicating in peer-to-peer mode, instruments can be set up to advance a test program on their own.

In another embodiment, the clock 140 in the controller 120 and the clocks 150 in the instruments 110 are synchronized using the IEEE/IEC 61588 (sometimes referred to as just IEEE-1588) time synchronization protocol. In this embodiment, the communication links 130 are LAN-based connections. The instruments 110 are LXI Class B compliant, so that the clocks 140 and 150 different instruments can all be coordinated and communications between the controller 120 and instruments 110 can be time-stamped. The clocks can be synchronized using other methods, including: network time protocol (NTP), MATLAB's Tic/Toc function, using a 10 MHz reference and counting oscillator ticks, etc.

Once the test system 100 is synchronized in this manner, the WAIT statements in the test program 170 can be eliminated. Instead, the commands to the instruments 110N can be time-triggered, meaning that the commands to the instruments are issued based on a common sense of time shared in the system. Table 3 shows an excerpt of pseudo-code from a time-triggered test program in a synchronized test system:

TABLE 3

| Line | Code |
|---|---|
| 0 | Close (@1) “close a switch”, start@time=Tₛₜₐᵣₜ |
| 1 | Send(110A, “Frequency:Sine:16kHz”, start @ time=Tₛₜₐᵣₜ+Δ1) |
| 2 | Send(110B, “Measure:Voltage”, start @ time=Tₛₜₐᵣₜ+Δ2) |
| 3 | Send(110N, “Set Voltage:4.5”, start @ time=Tₛₜₐᵣₜ+Δ3) |

Table 3 is a time-triggered version of Table 1, wherein the explicit “WAIT commands” have been replaced by time triggers (e.g. “Tₛₜₐᵣₜ”, “Tₛₜₐᵣₜ+Δ1”, “Tₛₜₐᵣₜ+Δ2”, and “Tₛₜₐᵣₜ+Δ3”) which implicitly incorporate the required WAIT period by staggering the times at which the measurement instruments start carrying out the commands. The controller sets up the instruments ahead of time (e.g. at some time T₀ before Tₛₜₐᵣₜ) to run the commands at the trigger times listed. Once Tₛₜₐᵣₜ rolls around, the instruments automatically perform the commands at the trigger times instructed by the controller, with no further action by the controller. This time-triggered test program has the advantage of eliminating communication delays between the instruments 110 and the controller 120, and delays within the instruments 110 themselves. For example, since the clocks are all synchronized to the same time, the messages can be time-stamped at the time of sending, at the time of receipt, and at the time a command is completed. From these time-stamps, the delay due to communication lag time can be determined and removed from the WAIT period. Other internal delays within the instrument can also be accounted for and removed from the WAIT period in the same manner by time stamping.

In one embodiment, the test program is run to gather statistics before any WAIT periods are adjusted. For example, in the flow chart of FIG. 2, steps 210-230 would be run multiple times to gather data on the response times before any adjustments are made. Relevant data includes: how long instruments take to complete the commands; how long instruments and the DUTs take to settle after changes are made; the statistical variations in these response times, the statistical variations in successful completions of the test program as the wait times are changed, etc. The controller can record the data on the response times in memory. Only after enough data had been gathered and stored would the WAIT periods be adjusted.

In one embodiment, the controller 120 checks to make sure the tests meet a certain threshold level of success after the WAIT period is adjusted (e.g. the test program fails less than 1 in 1000 times). The controller 120 may need a monitoring routine in the test program 170, or perhaps an external monitoring program that monitors the completion success rate (e.g. 99.9%) of the test program on the DUTs tested after the WAIT periods are adjusted. Certain processes can tolerate greater failure rates than others, so this is useful in tuning the efficiency of the test program to the specific needs of the user. If the success rate is lower than desired, the WAIT periods can be adjusted to be longer until the desired success rate is achieved.

The method of flow chart 200 and the various embodiments described above can be stored onto any processor-readable medium, such as a floppy disk, a disk drive, memory card, CD-ROM, DVD, etc.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A processor-readable medium having processor-readable code embodied on the processor-readable medium, the processor-readable code for programming one or more processors to perform a method of controlling a test system having at least one instrument, the method comprising:
running a test program on a device under test (DUT);
sending a command from a controller to the instrument;
waiting for a preset wait period set by the test program;
determining a response time of the instrument to the command; and
adjusting the preset wait period based on the response time.

2. A processor-readable medium as in claim 1, wherein determining the response time further comprises:
measuring the response time with a clock local to the controller.

3. A processor-readable medium as in claim 2, wherein the test program is run within a test development environment on a computer.

4. A processor-readable medium as in claim 2, further comprising:
determining whether a result of the command falls within specified limits; and
increasing the preset wait period when the result of the command does not fall within specified limits.

5. A processor-readable medium as in claim 1, wherein determining the response time comprises:
decreasing the preset wait period iteratively until the test program fails to complete successfully; and
setting the preset wait period to a value before the test program failed.

6. A processor-readable medium as in claim 1, wherein determining the response time further comprises:
receiving the response time as a value returned by the instrument.

7. A processor-readable medium as in claim 1, the method further comprising:
synchronizing a clock in the controller with a clock in the instrument.

8. A processor-readable medium as in claim 7, wherein synchronizing the clocks further comprises:
synchronizing the clocks using the IEEE 1588 standard.

9. A processor-readable medium as in claim 8, wherein sending the command includes a time trigger describing when the command is to be carried out by the instrument.

10. A processor-readable medium as in claim 1, the method further comprising:
gathering data on multiple response times before adjusting the preset wait period.

11. A processor-readable medium as in claim 10, wherein gathering data further comprises:
determining statistical variations in the response times.

12. A processor-readable medium as in claim 10, wherein adjusting the preset wait period is based on a threshold level of successful completions of the test program.

13. A processor-readable medium as in claim 1, wherein the preset wait period allows time for the instrument to settle in response to the command.

14. A processor-readable medium as in claim 1, wherein the preset wait period allows time for the DUT to settle in response to the command.

15. A processor-readable medium as in claim 1, wherein the test system further comprises a plurality of instruments, wherein the instruments communicate with each other to advance the test program.

16. An instrument for testing a DUT in a test system, comprising:
a controller port for communicating with a controller running a test program;
a local clock; and
a processor that calculates a response time of the instrument to a command received from the controller and returns the response time to the controller, wherein the response time is based on the local clock.

17. An instrument as in claim 16, wherein the local clock is synchronized to an external clock using the IEEE 1588 standard.

18. An instrument as in claim 17, wherein the processor is adapted to receive a time trigger and a command from the controller, wherein the processor starts the command at the time trigger.

19. A test system, comprising:
a controller in communication with at least one instrument, the controller capable of running a test program on a DUT, wherein the test program includes the steps of:
sending a command from a controller to the instrument;
waiting for a preset wait period;
determining a response time of the instrument to the command; and
adjusting the preset wait period based on the response time.

20. A test system as in claim 19, wherein the controller is a computer running a test executive.

21. A test system as in claim 19, wherein the instrument is selected from the group consisting of: multimeters, power supplies, oscilloscopes, signal analyzers, network analyzers, logic analyzers, spectrum analyzers, data analyzers, protocol analyzers, frequency counters, bit error rate testers, signal generators, function generators, trigger generation devices, lasers, power meters, polarimeters, wavemeters, time domain reflectometers, and optoelectronic component analyzers.
